(19) United States
(12) Patent Application Publication
(10) Pub. No.: US 2010/0278528 A1
(43) Pub. Date: Nov. 4, 2010

(54) Coherent optical receiver

(75) Inventors: Akihiko Isomura, Tokyo (JP); Jens C. Rasmussen, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/662,660

(22) Filed: Apr. 27, 2010

Related U.S. Application Data
(63) Continuation of application No. PCT/JP2007/071725, filed on Nov. 8, 2007.

(51) Int. Cl. H04B 10/08

(52) U.S. Cl. 398/25

(57) ABSTRACT

A coherent optical receiver includes; a multiplexing section that multiplexes local oscillation light and received signal light, and outputs two pairs of lights with optical phases different to each other, a photoelectric converting section that executes differential photoelectric converting to convert the output lights from the multiplexing section into electric signals, an AD converting section that converts the respective electric signals output from the photoelectric converting section into digital signals, a digital signal processing section that compensates wavelength dispersion by subjecting the digital signals converted by the AD converting section to arithmetic processing using a digital filter, and then executes reception processing of data included in the received signal light, a monitoring section that monitors an intensity component in a predetermined band of the electric signals output from the photoelectric converting section, and a tap coefficient adjusting section that determines a tap coefficient of the digital filter according to a monitoring result obtained by the monitoring section.

### CROSS-REFERENCE TO RELATED APPLICATION

This application is based upon and claims the benefit of priority of the prior PCT Application No. PCT/JP2007/071725, filed on Nov. 8, 2007, the entire contents of which are incorporated herein by reference.

### FIELD

The present invention relates to an optical receiver used for an optical transmission system, and in particular, relates to waveform compensation of a received signal in a coherent optical receiver.

### BACKGROUND

Recently coherent optical communication is attracting attention, with an increasing demand for higher speed and larger capacity of a network. This is because coherent optical communication is excellent in optical noise immunity and is less susceptible to an influence of relaying with amplification, thus alleviating restrictions on transmission distance.

As factors restricting the transmission distance in optical communication, there are noise and dispersion. Noise can be alleviated because, as mentioned above, coherent optical communication has excellent optical noise immunity. On the other hand, regarding dispersion, there is a main problem of the phase characteristic (dispersion characteristic) of the transmission line, especially, wavelength dispersion in that group delay of a signal light changes according to the wavelength (frequency). Wavelength dispersion causes an optical phase difference between local oscillation light having a reference frequency generated from a local oscillation light source included in an optical receiver for the coherent optical communication, and a received signal light.

However, in coherent optical communication, phase information can be obtained together with the intensity of the optical signal at the time of detection and conversion of the optical signal into an electric signal. Therefore, the influence of wavelength dispersion can be compensated based on the intensity and the phase information, at the stage of the detected and converted electric signal. That is, coherent optical communication has a high electric dispersion compensation capability for performing dispersion compensation at the stage of the electric signal, as compared with a conventional direct detection system in which only the intensity of light is extracted by square-law detection (for example, Satoshi Tsukamoto, Kazuhiro Katoh and Kazuro Kikuchi, “Unrepeated 20-Gbit/s QPSK Transmission over 200-km Standard Single-Mode Fiber Using Homodyne Detection and Digital Signal Processing for Dispersion Compensation”, Optical Fiber Communication Conference and Exposition 2006 (Non-Patent Literature 1)).

Dispersion compensation at the electric signal stage in the optical receiver in coherent optical communication is executed by using a digital filter depending on digital signal processing (DSP), particularly, a finite impulse response (FIR) filter (see Non-Patent Literature 1). In this case, an optimum tap coefficient in respect of the FIR filter needs to be determined based on an inverse transfer function of the optical fiber constituting the transmission line. That is, the tap coefficient of the FIR filter is obtained according to the following equation 1, by obtaining an inverse dispersion transfer function H⁻¹(ω)=exp(jω²β″L/2) of the optical fiber from a dispersion transfer function H(ω)=exp(−jω²β″L/2) of the optical fiber, where ω denotes the sampling frequency, Tₛ denotes the sampling interval, β″ denotes the dispersion coefficient, L denotes the length of the optical fiber, and k denotes the tap number (a value centering on 0, for example, when the number of taps is 19 as in the following example, a value of −9 to 9).

$${c}_{k} = \frac{1}{2 π} {\int }_{- π}^{π} exp [ {j ( \frac{ω}{{T}_{s}} )}^{2} {β}^{″} L / 2 + jω k ] d ω \qquad [ Equation 1 ]$$

The wavelength dispersion value of the optical fiber can change with time, and hence, the wavelength dispersion value needs to be monitored in order to set an optimum tap coefficient each time. A current configuration example is illustrated in FIG. 8 and FIG. 9.

In the coherent optical receiver adopting a polarization diversity receiving system illustrated in the figures, a received signal light E_{S} is input to one of the input ports of a 2×4 optical hybrid circuit 1, which is an optical 90-degree hybrid circuit having two input ports and four output ports. Moreover local oscillation light E_{LO} is input to the other input port of the optical hybrid circuit 1. The optical hybrid circuit 1 serving as a multiplexing section, combines the received signal light E_{S} and the local oscillation light E_{LO} and outputs two pairs of lights with optical phases different by 90 degrees to each other. For example, phases of light respectively output from two output ports of one pair illustrated on the upper side (A side) in the figure are 0 degree and 180 degrees, and phases of light respectively output from two output ports of the other pair illustrated on the lower side (B side) in the figure are 90 degrees and 270 degrees. The local oscillation light E_{LO} is generated by a local oscillation light generating section 2, in which a polarization component of a predetermined optical angle frequency and a polarization component of an optical angle frequency orthogonal thereto are polarization-multiplexed. A specific configuration for multiplexing and receiving the received signal light E_{S} and the local oscillation light E_{LO} by such a polarization diversity receiving system is described in detail, for example, in Japanese Laid-Open (kokai) Patent Publication No. 5-63657 (Patent Literature 1) and Japanese Laid-Open (kokai) Patent Publication No. 5-63658 (Patent Literature 2).

The two pairs of output lights output from the optical hybrid circuit 1 are detected respectively by executing differential photoelectric converting. This differential photoelectric converting is realized by using twin photodiodes (Twin-PD) 3 and 4, for example as described in Cechan Tian and Susumu Kinoshita, “Polarization-Independent Waveform Monitoring with Two-Photon Absorption in Si-APD in High-Speed Transmission Systems”, 2006 European Conference on Optical Communication (ECOC '06), We4 (Non-Patent Literature 2), and amplifying output signals thereof by transimpedance amplifiers (TIA) 5 and 6. As the photoelectrically converted signals, a signal (A side) having an intermediate frequency due to a beat between the polarization component of the predetermined optical angle frequency (x polarization component) included in the local oscillation light E_{LO} and the x polarization component of the received signal light E_{S}, and a signal (B side) having an intermediate frequency due to a beat between the polarization component of the orthogonal optical angle frequency (y polarization component) included in the local oscillation light E_{LO} and the y polarization component of the received signal light E_{S}, are output.

The signals on the A and B sides are AD converted by analog to digital converters (ADC) 7 and 8, and subjected to digital signal processing. That is, the AD converted signals are first monitored by a power deviation monitor 10, and the optical hybrid circuit 1 is controlled according to a monitoring result thereof. Subsequently, the signals are monitored by a frequency error monitor 11, and the local oscillation light generating section 2 is controlled according to a monitoring result thereof. Moreover both signals on the A and B sides are input to an FIR filter 12 serving as a digital filter having 19 taps, so that wavelength dispersion is compensated. The signals whose dispersions have been compensated by the FIR filter 12, are input to a forward error correction (FEC) section 15 via a clock recovery section 13 and a phase estimating section 14, where well-known error correction processing is executed and the number of error corrections is counted. A count value thereof is used for control and so forth of the local oscillation light generating section 2.

In the compensation of the wavelength dispersion by the FIR filter 12, in the case of FIG. 8, a wavelength dispersion measuring device 16 is used in order to determine an optimum tap coefficient corresponding to a wavelength dispersion value of the transmission line. The wavelength dispersion measuring device 16 receives the signal light E_{S} to measure wavelength dispersion thereof, and outputs a measurement result to a tap coefficient adjusting section 17. The tap coefficient adjusting section 17 stores a tap coefficient table TT created beforehand for each wavelength dispersion value, and a tap coefficient according to the measurement result is read from the tap coefficient table TT, and applied to the FIR filter 12.

Moreover the tap coefficient adjusting section 17 in the case of FIG. 9 sets an optimum tap coefficient by feedback adjustment involving searching for a tap coefficient having the least error in received data, from the tap coefficient table TT. That is, at first the tap coefficient adjusting section 17 reads a first tap coefficient from the tap coefficient table TT stored in the coefficient adjusting section 17, and sets it in the FIR filter 12. Then the tap coefficient adjusting section 17 acquires an error count value of the signal, whose wavelength dispersion has been compensated due to the setting, from the FEC section 15, and stores the count value thereof. Subsequently, the tap coefficient adjusting section 17 reads the next tap coefficient different from the first tap coefficient and sets it in the FIR filter 12. Then in the same manner, the tap coefficient adjusting section 17 acquires an error count value of the signal, whose wavelength dispersion has been compensated due to the setting, from the FEC section 15 and stores the count value. This process is repeated until all the corresponding tap coefficients of all wavelength dispersion values in the tap coefficient table TT are set, and respective error count values are compared with each other. As a result of comparison, the tap coefficient adjusting section 17 reads a tap coefficient with the smallest error from the table TT, and sets it as the tap coefficient of the FIR filter 12.

In the tap coefficient setting control with respect to the digital filter, when the wavelength dispersion measuring device is used as in the receiver illustrated in FIG. 8, the tap coefficient can be set by feedforward in quick response to a status change of the transmission line. However, the wavelength dispersion measuring device is very expensive, and has a disadvantage in cost performance of the coherent optical receiver. Moreover, on the other hand, in a feedback system in which errors due to all the settable tap coefficients are first measured to set the tap coefficient with the smallest error as a result thereof, as in the receiver illustrated in FIG. 9, there is a disadvantage in that too much time is required for startup of the device. Particularly, a tap coefficient setting process needs to be executed even if the wavelength dispersion value changes due to a change in the transmission line because of replacement of the optical fiber or the like, and hence, time is required for resetting the tap coefficient, which is undesirable.

### SUMMARY

In view of the above situation, a coherent optical receiver that can set a tap coefficient of the digital filter without using the wavelength dispersion measuring device, and has a short tap coefficient setting time, is needed.

The coherent optical receiver proposed herein, includes: a local oscillation light generating section; a multiplexing section that multiplexes local oscillation light output from the local oscillation light generating section and received signal light, and outputs two pairs of lights having different optical phases to each other; a photoelectric converting section that executes differential photoelectric converting to convert the two pairs of output lights from the multiplexing section into electric signals, respectively; an AD converting section that converts the respective electric signals output from the photoelectric converting section into digital signals; and a digital signal processing section that compensates wavelength dispersion of the received signal light by subjecting the digital signals converted by the AD converting section to arithmetic processing using a digital filter, and then executes reception processing of data included in the received signal light.

It is proposed that the coherent optical receiver further includes a monitoring section that monitors an intensity component in a predetermined band of the each electric signal output from the photoelectric converting section, and a tap coefficient adjusting section that determines a tap coefficient of the digital filter according to a monitoring result obtained by the monitoring section. Alternatively, it is proposed that the coherent optical receiver further includes a monitoring section that monitors an intensity component in a predetermined band of the each digital signal output from the AD converting section, and a tap coefficient adjusting section that determines a tap coefficient of the digital filter according to a monitoring result obtained by the monitoring section.

The object and advantages of the invention will be realized and attained by means of the elements and combinations particularly pointed out in the appended claims.

It is to be understood that both the foregoing general description and the following detailed description are exemplary and explanatory and are not restrictive of the invention, as claimed.

### BRIEF DESCRIPTION OF THE DRAWINGS

FIG. 1 is a block diagram of a coherent optical receiver according to a first embodiment of the present invention;

FIG. 2 is a graph simulating intensity change of electric signals on the A side and the B side with respect to wavelength dispersion of received signal light (In the figure, intensity component (arbitrary units) is plotted on the Y axis, and wavelength dispersion value (ps/nm) is plotted on the X axis);

FIG. 3 is a block diagram of an experimental apparatus that actually measures intensity change of electric signals on the A side and the B side with respect to wavelength dispersion of received signal light;

FIG. 4 is graphs showing results of actual measurements obtained by the experimental apparatus illustrated in FIG. 3;

FIG. 5 is simulation results obtained by examining an upper limit of a width of a pass band of a band pass filter;

FIG. 6 is a block diagram of a coherent optical receiver according to a second embodiment of the present invention;

FIG. 7 is a block diagram of a coherent optical receiver according to a third embodiment of the present invention;

FIG. 8 is a block diagram showing one example of a related coherent optical receiver; and

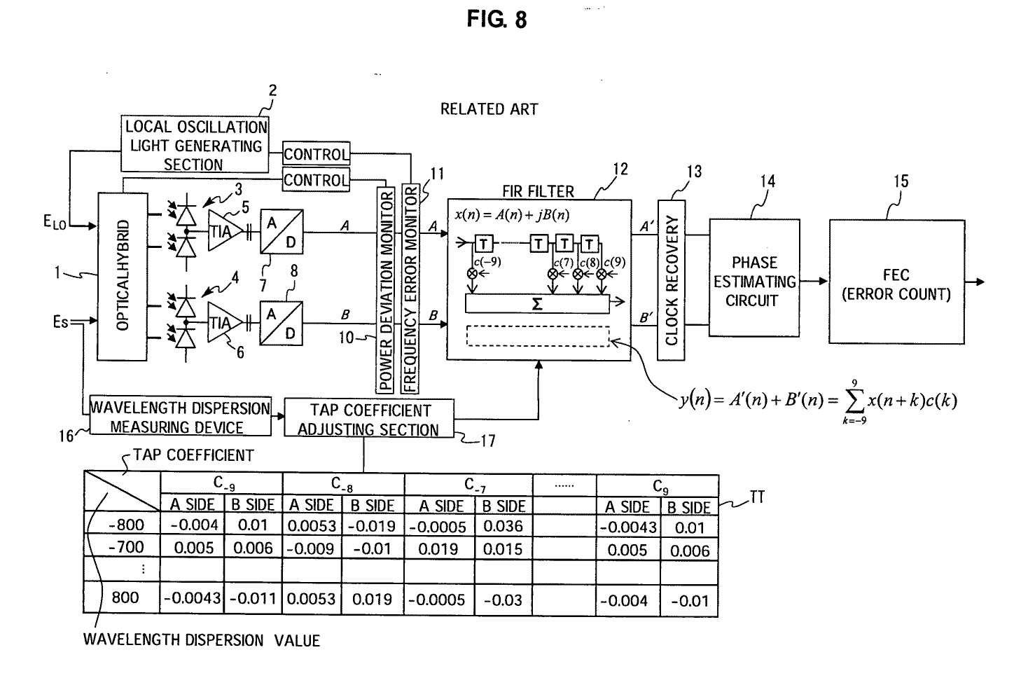

FIG. 9 is a block diagram showing another example of a related coherent optical receiver.

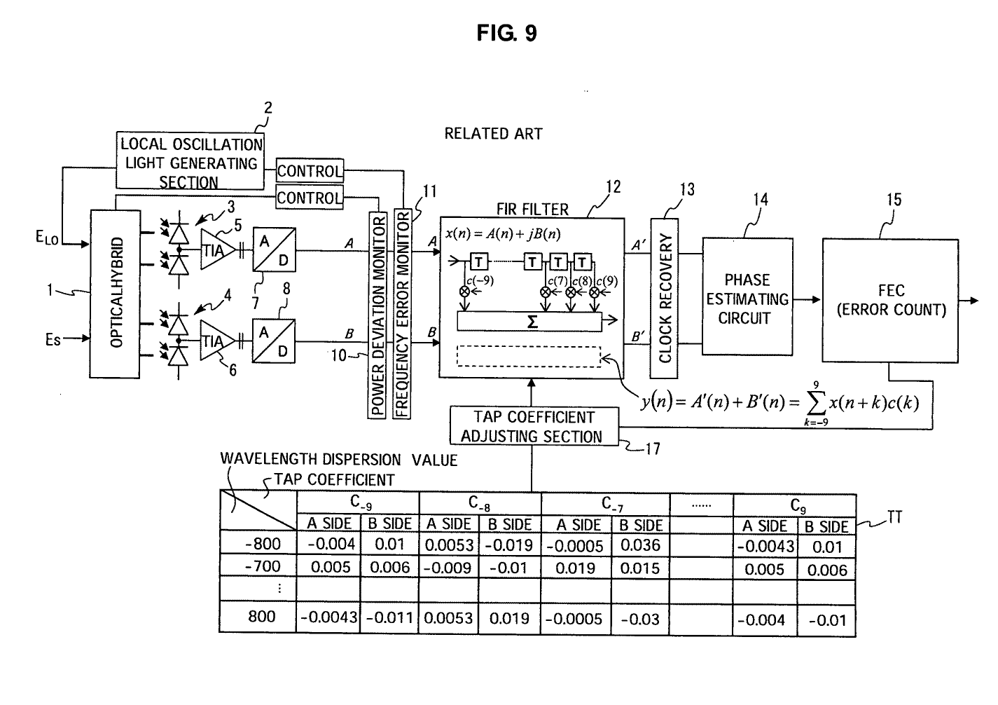

### DESCRIPTION OF EMBODIMENTS

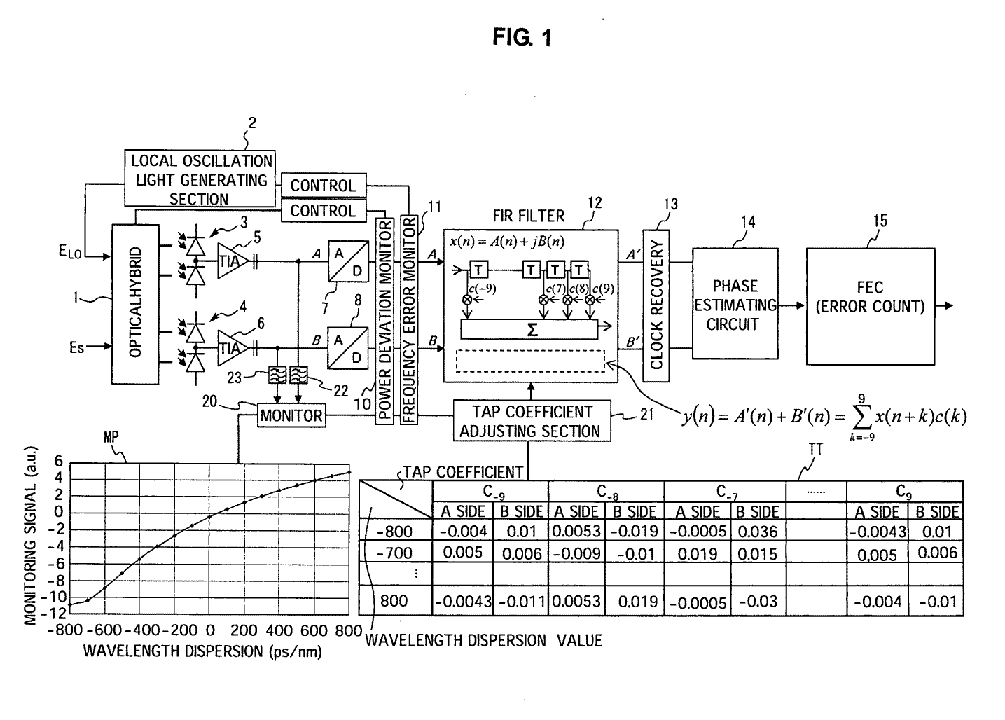

FIG. 1 illustrates a configuration of a coherent optical receiver according to a first embodiment.

The coherent optical receiver in this embodiment includes; a local oscillation light generating section, a multiplexing section, a photoelectric converting section, an AD converting section, and a digital signal processing section.

The multiplexing section adopts, for example, a polarization diversity receiving system and is configured by using a 2×4 optical hybrid circuit 1 that multiplexes local oscillation light E_{LO} and received signal light E_{S} respectively having an orthogonal polarization component with a different optical angle frequency to each other, and outputs two pairs of lights having different optical phases to each other. That is, the optical hybrid circuit 1 is an optical 90-degree hybrid circuit having two input ports and four output ports, and received signal light E_{S} is input to one of the input ports. Moreover local oscillation light E_{LO} is input to the other input port of the optical hybrid circuit 1. The optical hybrid circuit 1 multiplexes these received signal light E_{S} and local oscillation light E_{LO} and outputs two pairs of lights having optical phases different by 90 degrees to each other. For example, phases of light respectively output from two output ports of one pair shown on the A side (upper side) in the figure are 0 degree and 180 degrees, and phases of light respectively output from two output ports of the other pair shown on the B side (lower side) in the figure are 90 degrees and 270 degrees. The local oscillation light E_{LO} input to the optical hybrid circuit 1 is generated by the local oscillation light generating section 2, and is such that a polarization component of a predetermined optical angle frequency and a polarization component of an optical angle frequency orthogonal thereto are polarization-multiplexed.

Specific configuration examples of the optical hybrid circuit 1 and the local oscillation light generating section 2 are described in detail in Patent Literatures 1 and 2 as described above. Moreover the local oscillation light generating section 2 can have a required difference in the optical angle frequency between the orthogonal polarization components, as described in Japanese Patent Application No. 2006-338606 filed by the present applicant. Here an example is described in which the signal light E_{S} and the local oscillation light E_{LO} are multiplexed and received by the polarization diversity receiving system. However, the present invention is also effective for a coherent optical receiver which does not adopt the polarization diversity receiving system.

Two pairs of lights output from the optical hybrid circuit 1 are detected respectively by executing differential photoelectric converting, in the photoelectric converting section. The photoelectric converting section uses twin photodiodes 3 and 4 as described above, and is configured such that output signals thereof are respectively amplified by transimpedance amplifiers (TIA) 5 and 6. As the photoelectrically converted electric signals, a signal (A side) having an intermediate frequency due to a beat between the polarization component of the predetermined optical angle frequency (x polarization component) included in the local oscillation light E_{LO} and the x polarization component of the received signal light E_{S}, and a signal (B side) having an intermediate frequency due to a beat between the polarization component of the orthogonal optical angle frequency (y polarization component) included in the local oscillation light E_{LO} and the y polarization component of the received signal light E_{S} are output.

The electric signals on the A and B sides are converted into digital signals by analog to digital converters (ADC) 7 and 8 of the AD converting section, and then subjected to digital signal processing. That is, the AD converted digital signals are first monitored by a power deviation monitor 10, and the optical hybrid circuit 1 is controlled according to a monitoring result thereof so that power deviation of the respective electric signals on the A and B sides is reduced. Subsequently, the signals are monitored by a frequency error monitor 11, and the local oscillation light generating section 2 is controlled according to a monitoring result thereof so that the optical angle frequency of the local oscillation light E_{LO} is optimized. Then both signals on the A and B sides are input to an FIR filter 12 serving as a digital filter having 19 taps, and the wavelength dispersion is compensated. The signals whose dispersions have been compensated by the FIR filter 12, are input to a forward error correction (FEC) section 15 via a clock recovery section 13 and a phase estimating section 14, where error correction processing of received data is executed by using an error correction code included in the received signals, and the number of error corrections is counted. A count value thereof is used for control and so forth of the local oscillation light generating section 2.

In the wavelength dispersion compensation by the FIR filter 12, in order to determine an optimum tap coefficient corresponding to a wavelength dispersion value of the transmission line, a monitoring section 20 that monitors an intensity component in a predetermined band of the electric signals on the A and B sides output from the photoelectric converting section, and a tap coefficient adjusting section 21 that determines a tap coefficient of the FIR filter 12 according to a monitoring result of the monitoring section 20 are provided. The tap coefficient adjusting section 21 stores a tap coefficient table TT created beforehand for each wavelength dispersion value, and a tap coefficient according to the monitoring result of the monitoring section 20 is read from the tap coefficient table TT, and applied to the FIR filter 12.

The monitoring section 20 includes a band pass filter 22 that allows a predetermined band of the electric signal on the A side to pass therethrough, and a band pass filter 23 that allows a predetermined band of the electric signal on the B side to pass therethrough. That is, the monitoring section 20 monitors the intensity component of monitoring signals output through the band pass filters 22 and 23 provided with respect to each of the electric signals on the A and B sides. The electric signals passing through the band pass filters 22 and 23 are signals in which phase modulation is demodulated to intensity modulation due to photoelectric conversion, and a wavelength dispersion value of the received signal light E_{S} can be estimated by monitoring the intensity component thereof.

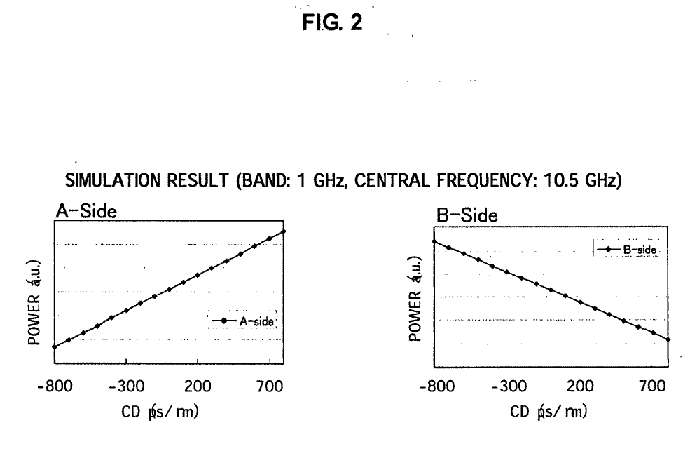

The monitoring section 20 in the first embodiment monitors a difference (A−B) between an intensity component of the monitoring signals on the A side obtained through the band pass filter 22 and an intensity component of the monitoring signals on the B side obtained through the band pass filter 23. As shown in the simulation results in FIG. 2, in the coherent optical receiver according to the first embodiment, the intensity component (Power) of the electric signal on the A side decreases as the wavelength dispersion value (CD) increases toward the − side, and increases as the wavelength dispersion value increases toward the + side. On the other hand, the intensity component of the electric signal on the B side increases as the wavelength dispersion value increases toward the − side, and decreases as the wavelength dispersion value increases toward the + side. Therefore, when a difference of the intensity components (A−B) of the monitoring signals obtained by extracting a predetermined band of the electric signals is associated with the wavelength dispersion value, a relation can be obtained such that; when the difference of the intensity components (A−B) is zero, the wavelength dispersion value also shows substantially zero, when the difference of the intensity components (A−B) increases toward the − side, the wavelength dispersion value also increases toward the − side, and when the difference of the intensity components (A−B) increases toward the + side, the wavelength dispersion value also increases toward the + side. Accordingly, the monitor map MP as illustrated in FIG. 1 can be formed.

The monitoring section 20 stores such a monitor map MP in a memory device, obtains the difference of the intensity components (A−B) of the monitoring signal output from the band pass filters 22 and 23, and accesses the monitor map MP to read a corresponding wavelength dispersion value. The read wavelength dispersion value is transmitted to the tap coefficient adjusting section 21, and a tap coefficient corresponding to the wavelength dispersion value is read from the tap coefficient table TT and set in the FIR filter 12. That is, the coherent optical receiver can monitor the wavelength dispersion of the transmission line without using an expensive wavelength dispersion measuring device, and can set an appropriate tap coefficient by feedforward in quick response to the change in the wavelength dispersion value.

The predetermined band of the electric signals passing through the band pass filters 22 and 23 is a band where half a symbol rate of the received signal light E_{S} is set as a central frequency. That is, for example, in the case of received signal light E_{S} of a quadrature phase shift keying (QPSK) system of 43 Gbps, the pass bands of the band pass filters 22 and 23 have a central frequency of half the symbol rate, that is, 10.5 GHz. This will be explained with reference to an experimental result.

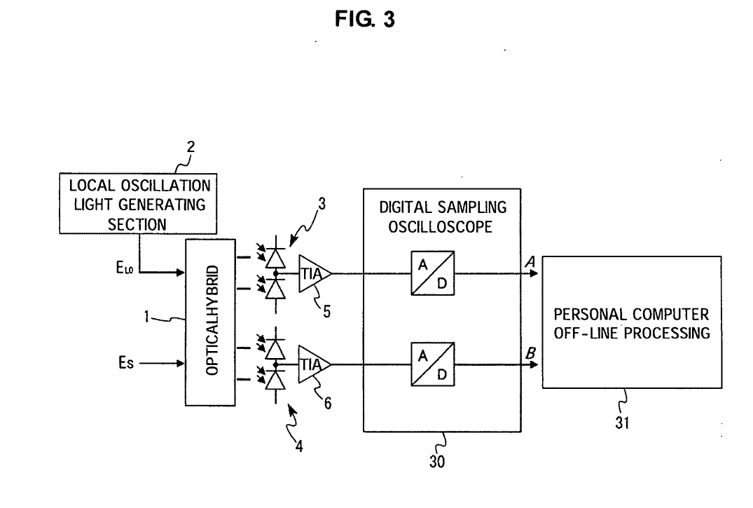

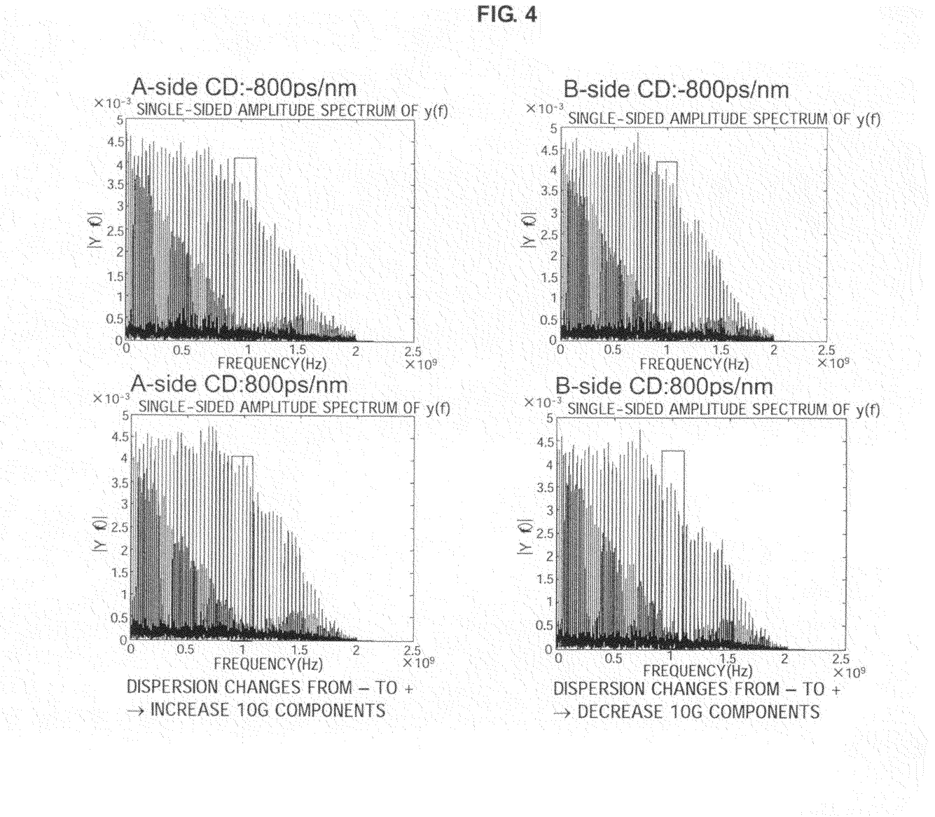

An experimental apparatus is as illustrated in FIG. 3, in which the electric signals on the A side and the B side obtained by using the optical hybrid circuit 1, the local oscillation light generating section 2, and the photoelectric converting section (3, 4, 5, and 6) as described above, are AD-converted in a digital sampling oscilloscope 30, and the converted digital signals are analyzed by a personal computer 31. Signal light in which a wavelength dispersion value is changed from −800 ps/nm to 800 ps/nm is input as the received signal light E_{S}, and frequency changes in the electric signals on the A and B sides are followed. As a result, as illustrated in FIG. 4, components of about 10 GHz increase in the electric signal on the A side, whereas components of about 10 GHz decrease in the electric signal on the B side. That is, experimental results coincident with the simulation results illustrated in FIG. 2 can be obtained in a vicinity of the central frequency of 10.5 GHz.

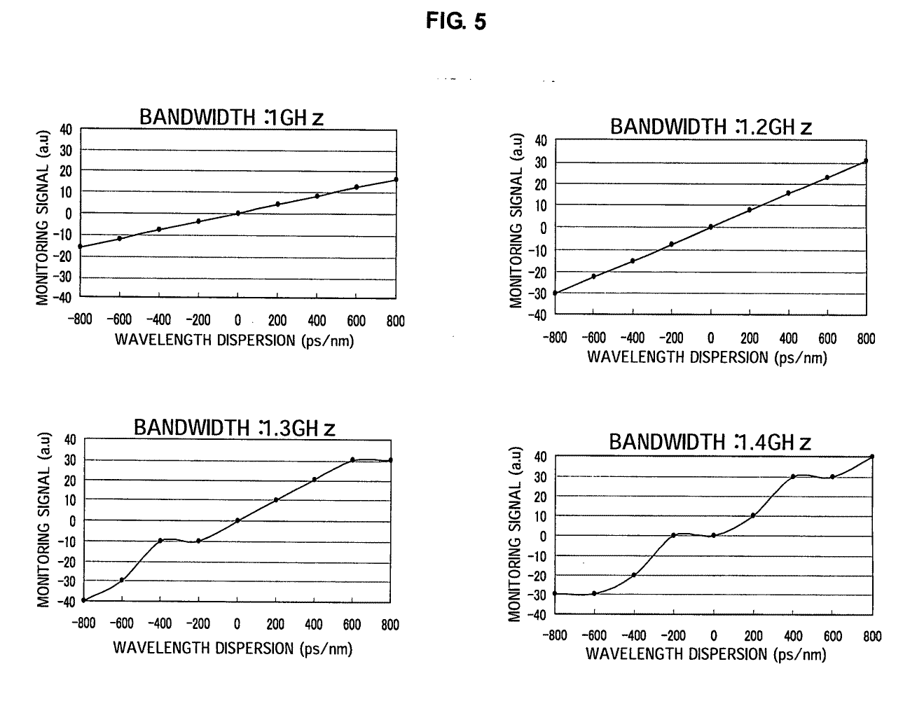

As for the bandwidth of the pass band of the band pass filters 22 and 23, under the above condition, about 1 GHz where half the symbol rate is set as the central frequency, is set as an upper limit of the bandwidth of the pass band. As shown in the simulation results in FIG. 5, when the bandwidth exceeds 1.2 GHz, linearity with respect to the wavelength dispersion value collapses, and hence, a range capable of maintaining the linearity is set. A lower limit of the bandwidth of the pass band depends on the dynamic range of a reception device used in the monitoring section 20.

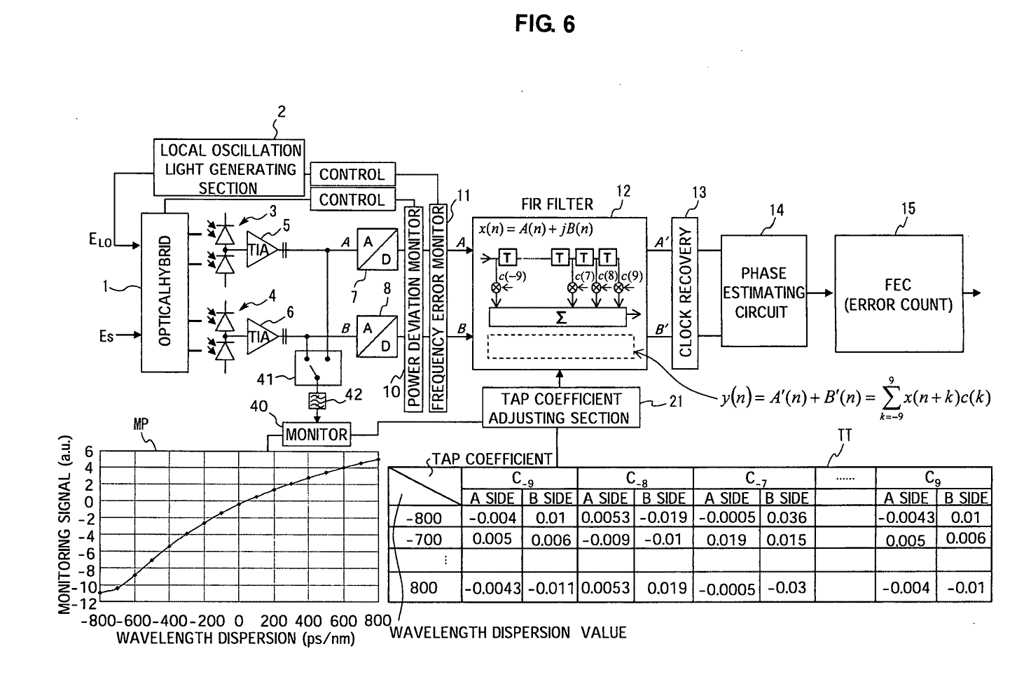

The monitoring section 20 in the above first embodiment includes a band pass filter for each of the electric signals on the A side and the B side. However, the electric signals on the A side and the B side can be switched to use only one band pass filter. A second embodiment having this configuration is illustrated in FIG. 6. The configuration other than the monitoring section according to the second embodiment of FIG. 6 is the same as that of the first embodiment.

A monitoring section 40 in the second embodiment includes a switch 41 that alternately transmits the respective electric signals on the A side and the B side, and a single band pass filter 42 that allows a predetermined band of the electric signals alternately transmitted by the switch 41 to pass therethrough. The central frequency and the bandwidth of the pass band of the band pass filter 42 are the same as those of the band pass filter in the first embodiment, and hence, monitoring signals on the A side and the B side as described above are alternately input to the monitoring section 40. The monitoring section 40 obtains a difference of the intensity components (A−B) from the alternately input monitoring signals, and obtains a wavelength dispersion value from the monitor map MP, and provides the wavelength dispersion value to the tap coefficient adjusting section 21.

According to the second embodiment, a monitoring error attributable to dispersion in the pass band of the filter can be reduced by using only one band pass filter.

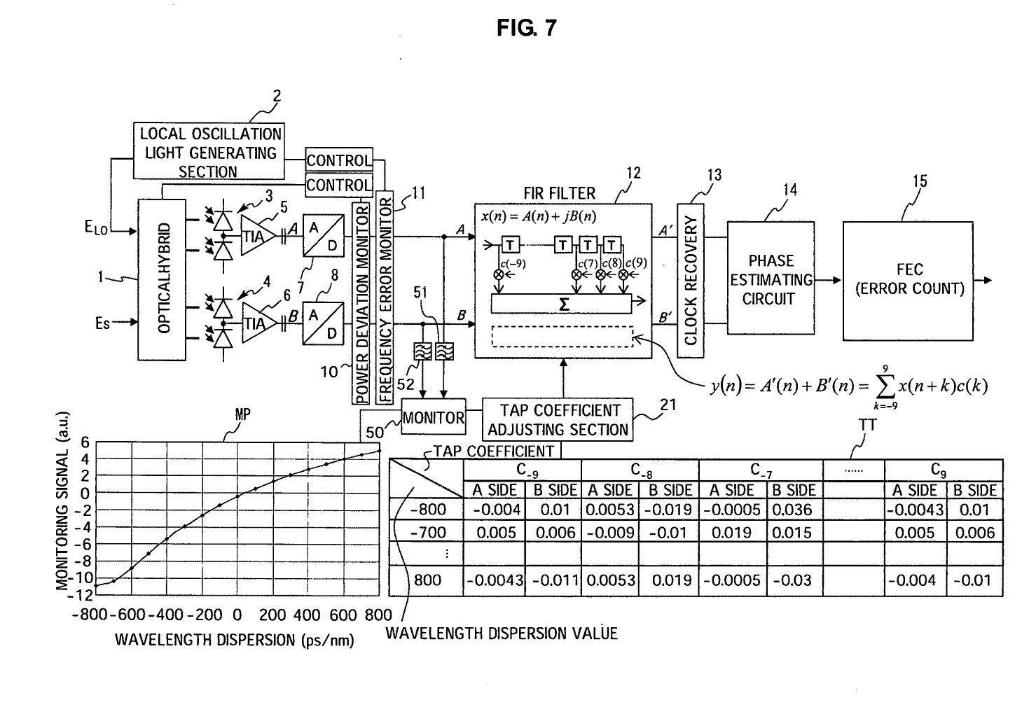

Moreover, the monitoring section 20 in the first embodiment uses the photoelectrically converted electric signals having passed through the band pass filters 22 and 23. However, AD-converted digital signal can also be used for the monitoring section. That is, a configuration for respectively monitoring an intensity component in a predetermined band of the digital signals output from the AD converters 7 and 8 is used, which is illustrated in FIG. 7 as a third embodiment. The configuration other than the monitoring section according to the third embodiment illustrated in FIG. 7 is the same as that of the first embodiment.

A monitoring section 50 in the third embodiment includes band pass filters 51 and 52 that respectively allow the digital signals on the A side and the B side output from the AD converters 7 and 8 to pass therethrough. The central frequency and the bandwidth of the pass band of the band pass filters 51 and 52 are the same as those of the band pass filters in the first embodiment, and hence, monitoring signals on the A side and the B side as described above are input to the monitoring section 50. The monitoring section 50 obtains a difference of the intensity components (A−B) from the respective monitoring signals, and obtains a wavelength dispersion value from the monitor map MP, and provides the wavelength dispersion value to the tap coefficient adjusting section 21.

Thus, a digital circuit including a monitoring section and a band pass filter is also possible.

The monitoring section according to the above-mentioned embodiments, monitors the intensity component in the predetermined band of the electric signal output from the photoelectric converting section or the digital signal obtained by digitally converting the electric signal. The intensity component changes in association with a wavelength dispersion value of the received signal light. Therefore, by monitoring the intensity component and selecting the tap coefficient, an appropriate tap coefficient can be set to the digital filter in quick response to the wavelength dispersion of the received signal light. That is, the wavelength dispersion of the transmission line can be monitored without using an expensive wavelength dispersion measuring device, and an appropriate tap coefficient can be set by feedforward in quick response to the change in the wavelength dispersion value, for example, when the state of the transmission line has changed. Accordingly, the tap coefficient can be promptly set at the time of startup of the device.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has(have) been described in detail, it should be understood that the various changes, substitutions, and alterations could be made hereto without departing from the spirit and scope of the invention.

What is claimed is:

1. A coherent optical receiver comprising:
a local oscillation light source;
a multiplexer that multiplexes local oscillation light output from the local oscillation light source and received signal light, and outputs two pairs of lights with optical phases different to each other;
a photoelectric converter that executes differential photoelectric converting to convert the two pairs of output lights from the multiplexer into electric signals, respectively;
an AD converter that converts the respective electric signals output from the photoelectric converter into digital signals;
a digital signal processor that compensates wavelength dispersion of the received signal light by subjecting the digital signals converted by the AD converter to arithmetic processing using a digital filter, and then executes reception processing of data included in the received signal light;
a monitor that monitors an intensity component in a predetermined band of the each electric signal output from the photoelectric converter; and
a tap coefficient adjuster that determines a tap coefficient of the digital filter according to a monitoring result obtained by the monitor.

2. A coherent optical receiver according to claim 1, wherein
the monitor comprises a band pass filter that allows the predetermined band to pass therethrough for each of the electric signals output from the photoelectric converter, and
the monitor monitors the intensity component of each monitoring signal output through the band pass filter.

3. A coherent optical receiver according to claim 1, wherein
the monitor comprises a switch that alternately transmits the respective electric signals output from the photoelectric converter, and one band pass filter that allows the predetermined band of the electric signal alternately transmitted by the switch to pass therethrough, and
the monitor monitors the intensity component of each monitoring signal output through the band pass filter.

4. A coherent optical receiver according to claim 1, wherein
the monitor monitors a difference of intensity components in the predetermined band of two electric signals output from the photoelectric converter.

5. A coherent optical receiver according to claim 1, wherein
the predetermined band is a band where half a symbol rate of the received signal light is set as a central frequency.

6. A coherent optical receiver comprising:
a local oscillation light source;
a multiplexer that multiplexes local oscillation light output from the local oscillation light source and received signal light, and outputs two pairs of lights with optical phases different to each other;
a photoelectric converter that executes differential photoelectric converting to convert the two pairs of output lights from the multiplexer into electric signals, respectively;
an AD converter that converts the respective electric signals output from the photoelectric converter into digital signals;
a digital signal processor that compensates wavelength dispersion of the received signal light by subjecting the digital signals converted by the AD converter to arithmetic processing using a digital filter, and then executes reception processing of data included in the received signal light;
a monitor that monitors an intensity component in a predetermined band of the each digital signal output from the AD converter; and
a tap coefficient adjuster that determines a tap coefficient of the digital filter according to a monitoring result obtained by the monitor.

7. A coherent optical receiver according to claim 5, wherein
the monitor monitors a difference of intensity components in the predetermined band of two digital signals output from the AD converter.

8. A coherent optical receiver according to claim 5, wherein
the predetermined band is a band where half a symbol rate of the received signal light is set as a central frequency.
